(19) United States
(12) Patent Application Publication
(10) Pub. No.: US 2023/0110925 A1
(43) Pub. Date: Apr. 13, 2023

(54) SYSTEM AND METHOD FOR UNSUPERVISED MULTI-MODEL JOINT REASONING

(71) Applicant: Huawei Cloud Computing Technologies Co., Ltd., Gui'an New District (CN)

(72) Inventors: Mohammad AKBARI, Coquitlam (CA); Amin BANITALEBI DEHKORDI, Vancouver (CA); Tianxi XU, Shenzhen (CN); Yong ZHANG, Richmond (CA)

(21) Appl. No.: 18/074,915

(22) Filed: Dec. 5, 2022

Related U.S. Application Data
(63) Continuation of application No. PCT/CN2021/081300, filed on Mar. 17, 2021.

(51) Int. Cl. G06N 5/02

(52) U.S. Cl. CPC G06N 5/02

(57) ABSTRACT

Method and system for predicting a label for an input sample. A first label is predicted for the input sample using a first machine learning (ML) model that has been trained to map samples to a first set of labels; If the first label satisfies prediction accuracy criteria it is outputted as the predicted label for the input sample; if the first label does not satisfy the prediction accuracy criteria, a second label is predicted for the input sample using a second ML model that has been trained to map samples to a second set of labels that includes the first set of labels and a set of additional labels, and the second label is outputted as the predicted label for the input sample.

### RELATED APPLICATIONS

This Application is a continuation of and claims benefit to International Patent Application No. PCT/CN2021/081300, filed Mar. 17, 2021, entitled SYSTEM AND METHOD FOR UNSUPERVISED MULTI-MODEL JOINT REASONING, the contents of which are incorporated herein by reference.

### FIELD

The present disclosure relates to artificial intelligence systems that include multiple prediction models, specifically systems and methods for unsupervised multi-model joint reasoning.

### BACKGROUND

Machine learning (ML) uses computer algorithms that improve automatically through experience and by the use of data. A machine learning training algorithm can be used to train an ML model based on samples from a training dataset, so that a trained ML model can make predictions or decisions without being explicitly programmed to do so. Neural Network (NN) models are types of ML models that are based on the structure and functions of biological neural networks. NN models are considered nonlinear statistical data modeling tools where the complex relationships between inputs and outputs present in training data are modeled to enable outputs to be predicted for new input samples. NN models can have varying levels of complexity. NN models that include multiple NN processing layers can be referred to as deep neural network (DNN) models.

Recent years have witnessed a tremendous growth in the development of DNN models having high prediction accuracy. However, high prediction accuracy require the use of extremely large DNN models that can require many NN processing layers and hundreds of billions of parameters that require extensive storage capacity, and/or an ensemble of multiple DNN models. This can result in time consuming, resource intensive performance of prediction tasks. One solution to alleviate the problem of slow prediction by large DNN models is to apply some form of model compression. Model compression covers various techniques such as quantization, knowledge distillation, pruning, and combinations thereof. After compression, the compressed DNN model may have a reduced number of parameters and/or operate with a lower bit precision. However, there is a trade-off between the compression ratio and accuracy of a model. Aggressive compression can lead to significant reduction in prediction accuracy of the compressed model. Moreover, compression provides one model that is inference-time deterministic with no flexibility over different input samples.

An alternative solution uses an adaptive inference approach to reduce inference latency (i.e. the time required to output a label for an input sample), whereby input samples can be routed to different branches of a DNN model either stochastically, or based on some decision criteria on input data. These methods for the most part are based on architecture redesign, i.e., the subject DNN model needs to be built in a specific way, to support dynamic inference. This makes the training of such models complex and imposes additional nontrivial hyper-parameter tuning.

Multi-model solutions to reduce inference latency have also been proposed whereby a support vector machine (SVM) classifier is leveraged to route work-load for an inference task. One example of such a solution is the Adaptive Feeding described in [Zhou, H. Y., Gao, B. B., & Wu, J. (2017). Adaptive feeding: Achieving fast and accurate detections by adaptively combining object detectors. In Proceedings of the IEEE International Conference on Computer Vision (CVPR) (pp. 3505-3513)], however such solution requires supervised training and is directed towards convolution neural networks. Furthermore, such solution cannot provide a dynamic trade-off between accuracy and computational cost at the inference (prediction) time. Rather, model retraining is required to provide different trade-offs.

Accordingly, there is a need for a multi-model solution that can be implemented without requiring supervised training and that can be applied to many different machine learning model architectures

### SUMMARY

According to a first aspect of the disclosure, a method is disclosed for predicting a label for an input sample. The method includes: predicting a first label for the input sample using a first machine learning (ML) model that has been trained to map samples to a first set of labels; determining if the first label satisfies prediction accuracy criteria; when the first label satisfies the prediction accuracy criteria, outputting the first label as the predicted label for the input sample; and when the first label does not satisfy the prediction accuracy criteria, predicting a second label for the input sample using a second ML model that has been trained to map samples to a second set of labels that includes the first set of labels and a set of additional labels, and outputting the second label as the predicted label for the input sample.

Such a method enables a joint inference system that in which the first ML model is specialized to predict labels that fall within a subset of the labels of the second ML model. The second ML model is used only if the label predicted by the first ML model does not satisfy the prediction accuracy criteria. Given that in the many datasets a majority of the samples will fall within a minority of the labels, the smaller, faster first ML model of the joint inference system enables faster inference for the subset of the labels than if the second ML model were used on its own. Furthermore, the first ML model will be smaller than the second ML model and thus require fewer computational resources (e.g., fewer computations, less memory requirements and less power demands) than the second ML model would require acting in isolation.

In some examples of the method of the first aspect, determining if the first label satisfies prediction accuracy criteria comprises evaluating if the input sample is in-distribution relative to a distribution that corresponds to the first set of labels, wherein when the input sample is evaluated to be in-distribution then the first label satisfies the prediction accuracy criteria.

In one or more examples of the method of the first aspect, evaluating if the input sample is in-distribution comprises: determining a free energy value for the input sample based on the predicted probabilities for all of the labels included in the first set of labels; and comparing the free energy value to a defined threshold to determine when prediction accuracy criteria is satisfied.

According to one or more of the preceding examples of the method o the first aspect, the first ML model predicts a probability for each of the labels included in the first set of labels, wherein evaluating if the input sample is in-distribution comprises: determining an entropy value for the input sample based on the predicted probabilities for all of the labels included in the first set of labels; and comparing the entropy value to a defined threshold to determine when prediction accuracy criteria is satisfied.

According to one or more of the preceding examples of the method of the first aspect, the first ML model is trained to map samples that fall within the second set of labels but not the first set of labels to a further label, and determining if the first label satisfies prediction accuracy criteria comprises, prior to evaluating if the input sample is in-distribution, determining if the first label predicted for the input sample corresponds to the further label, and if so then determining that the first label does not satisfy the prediction accuracy criteria.

According to one or more of the preceding examples of the method of the first aspect, the first ML model is a smaller ML model than the second ML model.

According to one or more of the preceding examples of the method of the first aspect, the first ML model and the second ML model are executed on a first computing system, the method including receiving the input sample at the first computing system through a network and returning the predicted label through the network.

According to one or more of the preceding examples of the method of the first aspect, the first ML model is executed on a first device and the second ML model is executed on a second device, the method comprising transmitting the input sample from the first device to the second device when the first label does not satisfy the prediction accuracy criteria.

According to one or more of the preceding examples of the method of the first aspect, the method further includes comprising, prior to predicting the first label, training the first model by: predicting labels for a set of unlabeled data samples using the second ML model to generate a set of pseudo-labeled data samples that correspond to the second set of labels; determining a subset of the second set of labels to include in the first set of labels based on the frequency of occurrence of the labels in the set of pseudo-labeled data samples; and training the first ML model using the set of pseudo-labeled data samples to map samples to the first set of labels. In some examples, training the first ML model comprises training the first ML model to map samples that fall within the second set of labels but not the first set of labels to a further label that corresponds to all of the second set of labels that are not included in the first set of labels.

Such a training method enables the first ML model to be trained in an unsupervised manner without a labeled training set.

According to one or more of the preceding examples of the method of the first aspect, the first ML model and the second ML model are deep neural network models and the first ML model has fewer NN layers than the second ML model.

According to a second example aspect, a method for predicting a label for an input sample is disclosed that includes: predicting a first label for the input sample using a first machine learning (ML) model that has been trained to map samples to a first set of labels by predicted respective probabilities for all of the labels included in the first set of labels; determining a free energy value for the input sample based on the predicted probabilities for all of the labels included in the first set of labels; comparing the free energy value to a defined threshold to determine if a prediction accuracy criteria is satisfied. When the prediction accuracy criteria is satisfied, outputting the first label as the predicted label for the input sample, otherwise when the prediction accuracy criteria is not satisfied predicting a second label for the input sample using a second ML model that has been trained to map samples to a second set of labels and outputting the second label as the predicted label for the input sample.

According to a third example aspect a computer system is disclosed comprising one or more processing units and one or more memories storing computer implementable instructions for execution by the one or more processing devices, wherein execution of the computer implementable instructions configures the computer system to perform the method of any one of the preceding aspects.

According to a fourth example aspect, a computer readable medium is disclosed that stores computer implementable instructions that configures a computer system to perform the method of any one of the preceding aspects.

### BRIEF DESCRIPTION OF THE DRAWINGS

Reference will now be made, by way of example, to the accompanying drawings, which show example embodiments of the present application, and in which:

FIG. 1 is a block diagram of a joint inference system according to example aspects of this disclosure;

FIG. 2 is a process flow diagram illustrating an example of training a small model of the joint inference system of FIG. 1;

FIG. 3 provides a graphical illustration of the operation of an energy function that can be incorporated into a selector module of the joint inference system of FIG. 1;

FIG. 4 is a block diagram of an example of the joint inference system of FIG. 1, showing an example of a selector module;

FIG. 5 is an example of a cloud computing environment in which the joint inference system may be employed;

FIG. 6 is a block diagram of a process that can be used to generate the small model of the joint inference system;

FIG. 7 shows examples of accuracy vs. inference time plots for different configurations of a small model in the joint inference system;

FIG. 8 is an example of a further accuracy vs. inference time plots for different thresholds applied by a selector module of the joint inference system;

FIG. 9 is a block diagram of a further joint inference system according to example aspects of this disclosure;

FIG. 10 is a block diagram of an example processing system that may be used to implement examples described herein; and

FIG. 11 is a block diagram illustrating an example hardware structure of a NN processor, in accordance with an example embodiment;

Similar reference numerals may have been used in different figures to denote similar components.

### DESCRIPTION OF EXAMPLE EMBODIMENTS

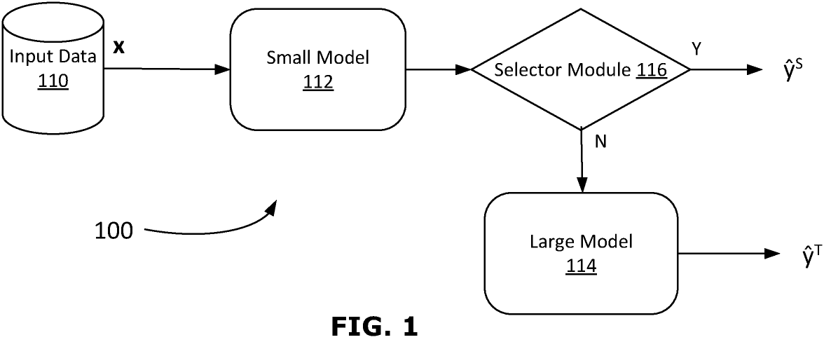

FIG. 1 is a block diagram of a joint inference system 100 according to example aspects of this disclosure. Joint inference system 100 combines a first ML model 112 and a second ML model 114 that is larger than the first ML model 112. As used here, “smaller” means that the first ML model 112 has fewer possible prediction outcomes than second ML model 114. In some example aspects, the second ML model 114 (hereinafter the “large model 114”) is a multilayer DNN model that has been trained to perform a prediction task that maps an input tensor (e.g., an input sample x) from input data 110 to one of C candidate labels Y^{T} (e.g., maps input sample x to a predicted label ŷ^{T} out of a total number of C possible outcomes). The first ML model 112 (hereinafter the “small model 112”) is a DNN model that has been trained to perform a prediction task that maps an input sample x to one of C̅ candidate labels Y^{s} (e.g., maps input sample x to a predicted label ŷ^{S} out of a total number of C̅ possible outcomes), where C̅ is less than C, and the set of C̅ candidate labels Y^{S} is a subset of the set of C candidate labels Y^{T}. In some applications the small model 112 can be considered a shallow model compared to the deeper, large model 114. Within the subset of C̅ labels Y^{S}, compared to the large model 114, the small model 112 can provide a higher speed inference. In contrast, the large model 114 will provide slower speed inference, but is able to classify all of the input samples belonging to the larger set of C candidate labels Y^{T} and may also provide higher prediction accuracy within the subset of C̅ labels Y^{S}. Accordingly, the small model 112 and large model 114 represent a trade-off between inference speed, classification breadth and prediction accuracy.

Joint inference system 100 is configured to exploit an underlying assumption that in most datasets, the majority of input samples (e.g., 80%) will, in most classification environments, be distributed within a relatively small subset of frequently predicted labels (e.g., 20 %). This is particularly the case for some cloud based ML services where the majority of data samples received from edge user devices will relate to a small/popular subset of candidate labels. Accordingly, a small model 112 that is trained to predict the most commonly occurring labels (e.g., subset of C̅ labels Y^{S}) can generally be expected to perform adequately for a majority of prediction tasks.

As used here, “label” corresponds to a prediction outcome resulting from a prediction by an ML model. In the case of a classification task where each possible prediction outcome corresponds to a respective class or category, the labels can correspond to class labels. Class labels will be used to denote possible prediction outcomes in the following description, however the ML models to which the systems and methods disclosed herein are not limited to ML classification models. As indicated in FIG. 1, the joint inference system 100 is configured to provide each input sample x to small model 112 to predict a class label. Joint inference system 100 includes a decision making selector module 116 that is configured to selectively route input samples x to the large model 114 based on predication accuracy criteria. As used here, a “module” can refer to a combination of a hardware processing circuit and machine-readable instructions (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit.

If the prediction task performed by the small model 112 meets the predication accuracy criteria, the class label ŷ^{S} generated by the small model 112 is used as the output prediction for joint inference system 100. If the prediction task performed by the small model 112 does not meet the predication accuracy criteria, the input sample x is routed by selector module 116 to large model 114 for a further prediction, and the class label ŷ^{T} generated by the large model 114 is used as the output prediction for joint inference system 100. This enables an inference system in which some input samples x (typically the majority) are processed solely by the higher speed, computationally efficient inference small model 112, and other input samples x are further routed to the large model 114, which is slower, but provides higher prediction accuracy. Accordingly, joint inference system 100 provides a run-time trade-off between inference latency and prediction accuracy. In examples, the predication accuracy criteria can be user configurable, enabling a user or administrator of the joint inference system 100 to select a point in the trade-off based on a desired accuracy or latency, without the need for re-training.

In some examples, selector module 116 applies predication accuracy criteria that corresponds to a type of out-of-distribution (OOD) data detection such that selector module 116 is configured to detect input samples that are sufficiently different from the training data (i.e., in-distribution samples)corresponding to set of C̅ candidate class labels that the small model 112 has been trained in respect of. In such examples, the selector module 116 is configured to evaluate if input samples fit within a distribution that corresponds to the class labels that the small model 112 has been trained in respect of (e.g., easy cases) or not (e.g., hard cases). If an input sample is evaluated to be an in-distribution sample, there is a high probability that it is a sample that can be accurately classified by the small model 112. If an input sample is evaluated to be OOD relative to the training data that corresponds to the set of class labels used for training the small model 112, the likelihood that the input sample is a hard case that will have a higher likelihood of inaccurate classification by small model 112 increases.

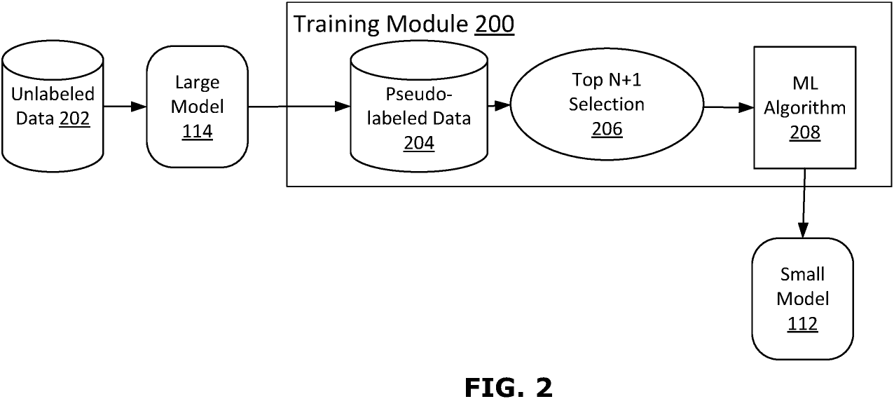

In order to provide context regarding OOD input samples, training of the small model 112 will now be described. In some examples, the large model 114 is a pre-trained model and is used to train the small model 112 in an unsupervised manner (i.e., without using any pre-labeled training data). In this regard, FIG. 2 illustrates a process that can performed by a training module 200 for training small model 112. In the process of FIG. 2, inputs to the training process include the pre-trained large model 114 and an unlabeled training dataset 202. Retraining or further training of the large model 114 is not required to implement joint inference system 100.

The large model 114 is used to generate a set of predicted class labels for each of the input samples included in unlabeled training dataset 202. The set of predicted class labels provides a pseudo-labeled training dataset 204, where “pseudo-labeled” refers to the fact that the labels applied to the input samples included in the pseudo-labeled training dataset 204 are predicted by a model rather than human-confirmed ground truth labels. A Top-N +1 analysis 206 is then performed to identify the top N most frequently occurring class label categories from the C class label categories that occur within the pseudo-labeled training dataset 204. As indicated above, for most datasets, as a general rule, a small group of class label categories will occur with greater frequency relative to a larger group of class label categories that will occur less frequently. In view of this, the small model 112 can be trained and specialized to be highly accurate on the more popular group of class labels, namely the top N appearing class labels (where N═C̅ .In example embodiments, the value of N can be set as a hard value (e.g., N=10 class label categories), or based on number that corresponds to the most frequency occurring class label categories (e.g., N= number of classes that make up top 70% of class label occurrences), or combinations thereof, or based on other criteria. In examples, the top N class label categories will correspond to the subset of 0C̅ class labels Y^{S}. For the purposes of training the small network 114, all of the input samples that are included pseudo-labeled dataset 204 that do not fall within the top N class label categories will be assigned a common label (e.g., “other” class label), such that the pseudo-labeled dataset 204 will include input samples that are distributed among N+1 possible class labels. Any number of known ML algorithms 208 can then be used to train a small model 144, using the pseudo-labeled dataset 204, to map an input to sample to one of N+1 label classes, namely the subset of C̅ class labels Y^{S} and the “other” class label that represents the collective group of labels in the group of C class labels Y^{T} that fall outside of the subset of C̅ class labels Y^{S}.

In one example of the disclosure, an automated unsupervised training process performed by training module 200 can be summarized as follows. Training module 200 is provided with unlabeled training dataset 202 and a pre-trained large model 114 that is configured to map input samples to one of C candidate class labels Y^{T}. The training module 200 uses the larger model 112 to generate pseudo-labels for unlabeled training dataset 202, resulting in pseudo-labeled training dataset 204. The pseudo-labeled training dataset 204 is analyzed using a Top N+1 analysis 206 to extract the top-N class labels with the most number of samples, where N<<C. An extra class label (“other” N+1 class) is reserved for the other C-N classes included in the C candidate class labels Y^{T}. An ML training algorithm 208 is then used to train the small model 112 using all of the training input samples in the pseudo-labeled training dataset 204, which includes input samples that are labeled with either one of the top N class labels or with the N+1 other class label. In example embodiments, during a prediction task, the small model 112 will generate a tensor of N+1 logits that respectively correspond to probability values for an input sample belonging to each of the top N candidate class labels and the N+1 “other” class label. A Softmax function can be applied to normalize the logits to between 0 and 1 with a total sum of 1. The class label that corresponds to the highest normalized Softmax value is output as the predicted class label for the input sample.

It will be noted that the training module 200 does not require the original training data set that was used to train large model 114, but rather relies on the use of an unlabeled training dataset 202 to transfer or distill knowledge from the large dataset to the small model 112. This can allow the unlabeled training dataset 202 to be drawn from input samples that fit close to those that the joint inference system 100 will be expected to process. In some examples, small model 112 may optionally be fine-tuned using some or all of the samples from a labeled training dataset such as the dataset that was originally used to train the large model 114, if such samples are available.

Once the small model 112 is trained, it can be combined with the large model 114 that was used to train it, and with the selector module 116, to form the joint inference system 100 of FIG. 1. The predication accuracy criteria applied by selector module 116 can differ in different examples in order to differentiate between OOD-type input samples (which require routing to large model 114) and in-distribution type input samples (where the small model 112 generated class label ŷ^{S} can be relied on).

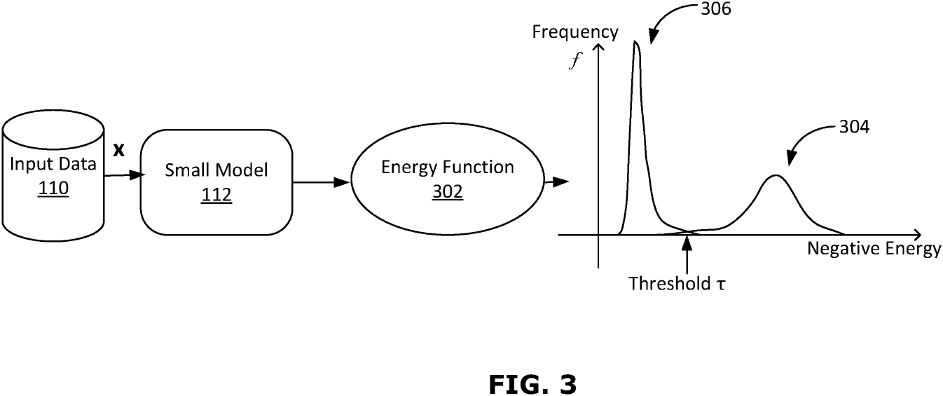

In one example according to the present disclosure, the predication accuracy criteria is based on the output of an energy function F(x;S) that computes an energy value for input sample x (where S denotes the logits of the output layer of the small model). In this regard, selector module 116 is configured to apply energy function F(x;S) to map the input sample to a scaler, non-probalistic energy value y_{E}. FIG. 3 provides a graphical illustration of the operation of an energy function 302 that can be incorporated into selector module 116.

In examples of the present disclosure, energy values can be defined based on the following. Given an input data point x, an energy function can be defined as E(x): R^{D} → R to map input x to a scaler, non-probabilistic energy value y. The probability distribution over a collection of energy values can be defined according to the Gibbs distribution:

$$p \left(y \vert \text{x}\right) = \frac{{e}^{- E \left(\text{x,y}\right)}}{Z} ,$$

Where Z is the partition function defined as:

$$Z \left(\text{x}\right) = {\int }_{{y}^{′}} {e}^{- E \left(\text{x,} {y}^{′}\right)} .$$

A ‘Helmholtz free energy’ of x can then be expressed as the negative log of the partition function as follows:

$$F \left(\text{x}\right) = - l o g \left(Z \left(\text{x}\right)\right) .$$

The small model 112 can be denoted as function

$${\overline{S}}^{c} \left(x\right) : {ℝ}^{D} \to {ℝ}^{\overline{C} + 1} ,$$

where C̅ « C, that maps an input sample x to C̅ + 1 real valued logits (which correspond to the C̅ class labels and the “other” class label). The tensor output of a softmax function can be used to represent a categorical distribution that is a probability distribution overC̅ possible outcomes (i.e., the extra “other” class is not included), as represented equation (1):

$$p \left(y \left|x\right)\right) = \frac{{e}^{{\overline{s}}_{y}^{c} \left(x\right)}}{{\sum }_{i}^{\overline{C}} {e}^{{\overline{s}}_{i}^{c} \left(x\right)}} \text{with} \text{i} ∈ \left\{1 , … , \overline{C}\right\} ,$$

where

$${\overline{S}}_{y}^{c} \left(x\right)$$

denotes the logit (probability) of the yth class label, and

The energy for a given input (x,y) can be defined as

$$E ( x , y ) = - {\overline{S}}_{y}^{c} \left(x\right) .$$

A free energy function can denoted as:

$${\overline{F}}^{c} \left(x ; {S}^{\overline{C}}\right) = - log {\sum }_{i}^{\overline{C}} {e}^{{\overline{S}}_{i}^{c} \left(x\right)} \text{with} \text{i} ∉ \left\{\overline{C} + 1\right\} .$$

The free energy

$${\overline{F}}^{c} \left(x ;\right) \left({S}^{\overline{c}}\right)$$

is calculated only over the small model 112 output logits that correspond to the top N═C̅ class labels, and does not include the logit that corresponds to the extra N=1 class. In particular, the free energy is calculated based on the logits (e.g., softmax values) generated by small model 112 for all N═C̅ of the candidate label classes Y^{S}, but excludes the softmax value generated in respect of the other “N+1” class label.

As the small model 112 has been trained to only predict subset C of the total of the C candidate class labels of large model 114, and to classify excluded class labels in the “other” class label, the energy difference

$${\overline{F}}^{c} ( {x}_{i} {S}_{i}^{c} ) - {\overline{F}}^{c} ( {x}_{i} {S}_{j}^{c} )$$

between in-distribution input samples and ODD input samples, respectively denoted as (x,i) and (x̅,j), will tend to be large where j ∈ [1,C̅| and i ∉ |1,C̅].

The larger the energy difference, the better the selector module 116 can distinguish between input samples that are fit for the small model 112 and those that should be routed to the large model 114. FIG. 3 illustrates a plot of frequency v. negative energy illustrating free energy distributions 306 and 304 for OOD input samples and in-distribution input samples, respectively. As indicated in FIG. 3, a free energy threshold t can be selected to delineate between input samples that should be routed to the large module 112 for a further inference prediction and input samples for which the small model class label prediction can be relied upon without requiring use of large model 114. In particular, noting that free energy is a negative value in FIG. 3, input samples that have a negative free energy value that is smaller than t can be identified as falling within free energy distribution 306 that corresponds to OOD input samples (i.e., route to large model 114 as small model 112 class label prediction has high probability of being inaccurate), and input samples that have a negative free energy above t can be identified as falling within the free energy distribution 304 that corresponds to in-distribution input samples (i.e., small model 112 class label prediction has high probability of being accurate).

In example embodiments, selector module 116 can be denoted as

$$\overline{V} ( x ; {\overline{S}}^{C} , t ) ∈ ( 0 , 1 ) ,$$

expressed as:

$$\overline{V} \left(\text{x} ; {\overline{S}}^{c} , t\right) = \left\{\begin{matrix}1 \text{if} - {\overline{F}}^{c} \left(\text{x} ; {\overline{S}}^{c}\right) \geq t \\ 0 \text{if} - {\overline{F}}^{c} \left(\text{x} ; {\overline{S}}^{c}\right) < t\end{matrix}\right\}$$

In the case where

$$\overline{V} \left(x ;\right) {\overline{S}}^{c} , t ) = 1$$

, the selector module 116 can select the class label ŷ^{S} generated by the small model 112 as the joint inference system 100 output for input sample x. In the case where

$$\overline{V} \left(x ;\right) {\overline{S}}^{c} , t ) \neq 1$$

, the selector module 116 can route the input sample x to large model 114 for a further class label prediction.

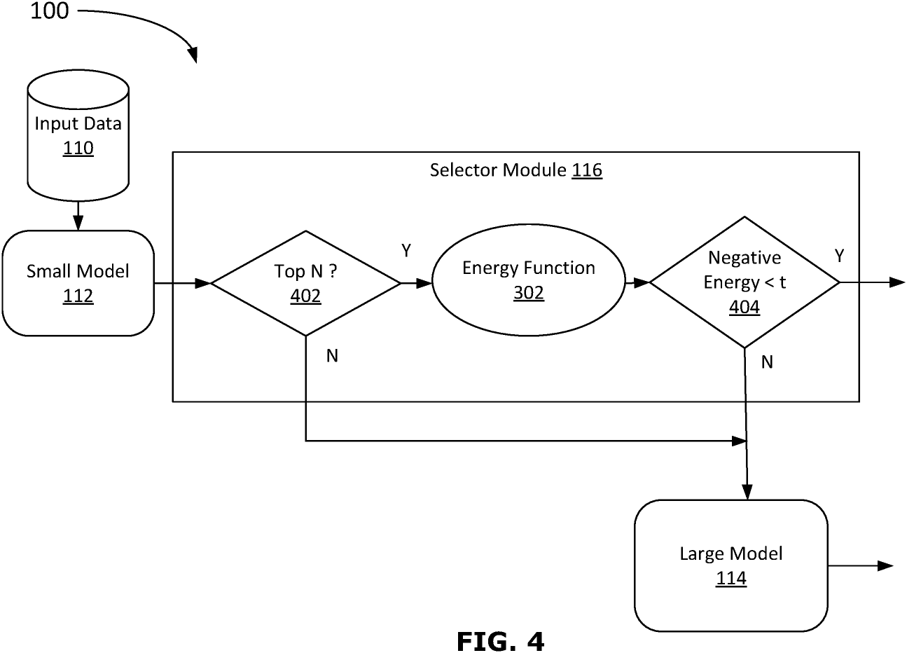

In some examples, the predication accuracy criteria applied by selector module 116 can be further enhanced by making direct use of the “other” N+1 class label. In particular, if the small model 112 assigns the “other” N+1 class label to a particular input sample x, it is clear that the small model 112 has not recognized the input sample x as falling within one of the Top N class labels Y^{s}. Accordingly, selector module 116 can immediately route such input sample x to large model 114 for a further class label prediction without resorting to any calculations by energy function 302. An example of selector module 116 that applies such a selection process is illustrated in the joint inference system 100 of FIG. 4. As noted in FIG. 4, selector module 116 applies a first decision operation 402 to determine if the class label predicted by small model 112 for an input sample x corresponds to a Top N label class. If not, the input sample x falls within the “other” N+1 class label and routed immediately to large model 114 for more accurate classification. If the class label predicted for input sample x corresponds to one of the Top N label classes, there is still a possibility that it may be inaccurately labeled. Thus, energy function 302 is applied to generate negative energy value in respect of the input sample x, and selector module 116 applies a second decision operation 404 to determine if the negative energy is less than the threshold t in which case the class label predicted by small model 112 can be used as the joint inference system 100 output, otherwise the input sample x is routed to large model 114 for more accurate classification.

In place of equation (6), the operation of the selector module 116 in FIG. 4 can be represented as:

$$\overline{V} \left(\text{x;} {\overline{S}}^{c} , t\right) = \left\{\begin{matrix}1 & \text{if} - {\overline{F}}^{c} \left(\text{x;} {\overline{S}}^{c}\right) \geq t \text{and} {\overline{S}}^{c} \left(\text{x}\right) ∈ \left[1 , \overline{C}\right] \\ 0 & \text{if} - {\overline{F}}^{c} \left(\text{x;} {\overline{S}}^{c}\right) < t \text{or} {\overline{S}}^{c} \left(\text{x}\right) ∈ \left\{\overline{C} + 1\right\} ,\end{matrix}\right)$$

where C̅ + 1 denotes the extra class defined in S̅^{c}

In some alternative examples, the energy function 302 and second decision operation 404 may be omitted from the predication accuracy criteria applied by selector module, which may rely solely on the Top N decision operation 402. In further alternative examples, the energy function 302 and negative energy threshold decision may be replaced with a different confidence metric. For example, an entropy calculation, such as those known from multi-exit DNN models, could be performed over all of the class label predictions for an input sample, with input samples that have an entropy score less than a defined threshold being selectively routed to the large model 114.

In example embodiments, the threshold value t can be user-specified, allowing the user to adjust the trade-off between accuracy and speed of the inference system 200.

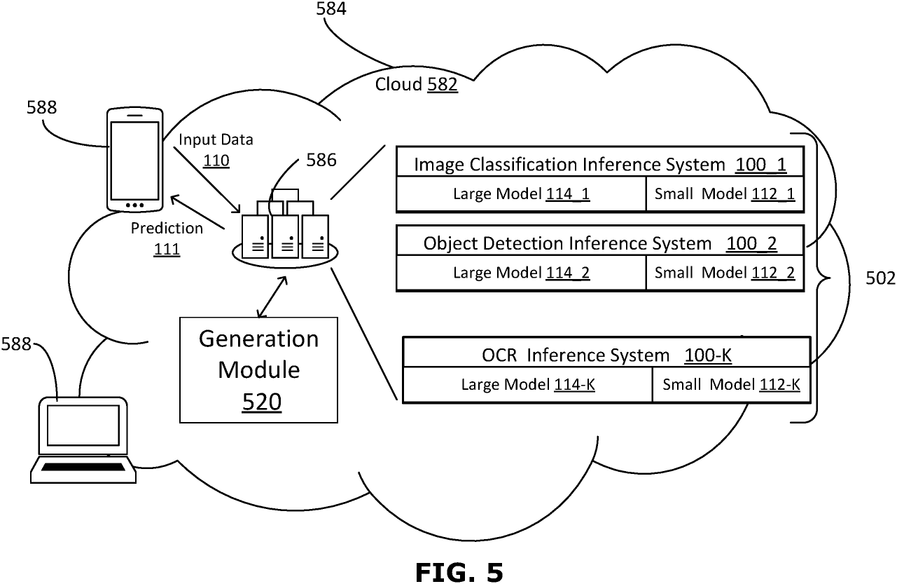

FIG. 5 illustrates an environment in which one or more inference systems 100 are implemented. In the example of FIG. 5, a cloud computing system 586 hosts an inference service 502 that is configured to receive input data 110 through a cloud network 582 (e.g., network that includes the Internet) from user devices 588 and perform inferences on the input data 110 to generate class label predictions 111 that are transmitted back to the requesting user device 588. Cloud computing system 586 can include one more cloud devices (for example a cloud server or a cluster of cloud servers) that have extensive computational power made possible by multiple powerful and/or specialized processing units and large amounts of memory and data storage. Cloud computing system 586 can also include less powerful cloud devices. User devices 588 may for example be edge devices that connect through local networks to the cloud network 582, and can include, among other things, smart-phones, desktop and laptop personal computers, tablet computers, smart-home cameras and appliances, authorization entry devices (e.g., license plate recognition camera), smart-watches, surveillance cameras, medical devices (e.g., hearing aids, and personal health and fitness trackers), various smart sensors and monitoring devices, and Internet of Things (IoT) devices.

In the example of FIG. 5, cloud computing system 586 supports inference service 502 by hosting multiple specialized joint inference systems 100, which may include for example: an image classification joint inference system 100_1, an object detection joint inference system 100_2, a text-to-speech inference system, a speech recognition inference system, and an optical character recognition (OCR) joint inference system 100_K, among others. Each of the inference systems 100_k can include a respective large model 114_k and small model 112_k (where k ∈ {1, ...,K)}), and a respective selector module 116 (not shown in FIG. 5).

In some examples, each of the large model 114_k, small model 112_k and selector module 116 may be hosted on a common computing device (e.g., a cloud server) of cloud computing system 586, and in some examples the functionality of large model 114_k, small model 112_k and selector module 116 may be distributed amongst multiple computing devices.

In at least some examples, one or more of the small models 112 and corresponding selector modules could be hosted remotely from the respective large models. For example, in the case of image classification joint inference system 100_1, the large model 114_1 could be executed on a powerful could server of cloud computing system 586, with the small model 112_1 and selector module 116 being executed on a user device 588. In such a combination the user device 588 will use locally generated class label predictions for easy input samples (i.e., Top N and above energy threshold input samples), and will direct harder input samples to the large model 114_1 to take advantage of the greater accuracy and computing resources available on cloud computing system 586.

It will be noted that each of the specialized inference systems 100_1 to 100_K is directed to a different type of classification tasks. For example, an image classification task classifies an entire image, whereas as an object detection task generates a bounding box location and size for an object and a classification of the object. Image classification tasks can apply regression to jointly predict a bounding box and class label.

In example embodiments, the structure of joint inference system 100 can be applied for many different types of ML classification models. By way of non-limiting example, in an illustrative embodiment a ResNet-152 DNN model architecture may be used to implement the large model 114, which is used to train a smaller ResNet-18 DNN architecture to implement the small model 112. In the case of object detection, a Yolo-xlarge DNN model architecture may be used to implement the large model 114, which is then used to train a Yolo-small DNN model architecture to implement the small model 112.

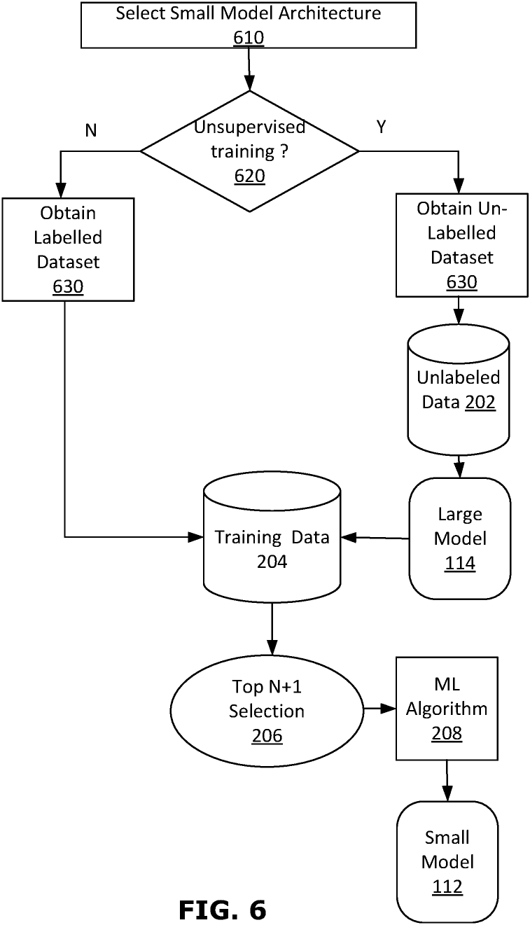

In some example embodiments, an interactive inference system generation module 520 that incorporates the training module 200 is hosted by a computer system (for example by cloud computer system 586) provides an interface (for example through an application program interface API available via user device 588) that enables a user (for example a developer) to create a customized joint inference system 100. In this regard, FIG. 6 shows an example of a process for generating small model 112 interactive joint inference system 100 according to an example of the present disclosure.

At 610, the small model architecture is selected. In some examples, a user may be given an option to indicate the particular type of inference task (e.g., images classification, object detection, etc.) and then select from a set of possible small model architectures for that task (e.g., ResNet-18, Yolo-small). In some examples, the small model architecture may be automatically selected by the generation module 520 based on user inputs that identify the architecture and/ or operating characterizes of large model 114. The user may in some examples be given the option of automatic selection of the small model architecture, or to allow the architecture to be automatically determined.

After the small model architecture is selected, at 620 the user is presented with the option to select supervised (training with labeled dataset) or unsupervised (training with unlabeled dataset). The unsupervised option has been discussed above, and as indicated at 630 requires that the generation module 520 obtain an un-labeled training dataset 202 which is then labeled using large model 114 to generate a pseudo-labeled training dataset 204. The unlabeled dataset 202 may be provided by a user in some examples (e.g. Open Images Dataset (OID) training set). In some examples, the generation module 520 may be configured to automatically collect samples and build unlabeled dataset 202. For example, the generation module 520 may be configured to scrub known databases for samples that conform to a user specified inference task.

Although supervised tuning of small model 112 is disclosed as an option above, if at 620 a user selects the option for complete supervised training of small model 114, then as indicated at 630 a labeled dataset is obtained by the generation module 520 and is used as the training dataset 204 (in which case, the training dataset may be a human confirmed ground-truth labeled dataset rather than pseudo-labeled). The labeled dataset may be provided by the user, or may be obtained from a known source by the generation module 520 based on the intended inference task. In the event that supervised training is selected, then a large model generated pseudo-labeled dataset is not required.

Top N+1 selection 206 is then performed in respect of the (human or pseudo-) labeled training dataset 204 to select the set of C̅ small model candidate class labels Y^{S} from the larger set of C candidate class labels included in the training dataset 204. In some examples, a user may be presented with the option to specify the value of N, or to have the generation module 520 automatically determine the value of N based on the predetermined criteria (e.g., top 70%).

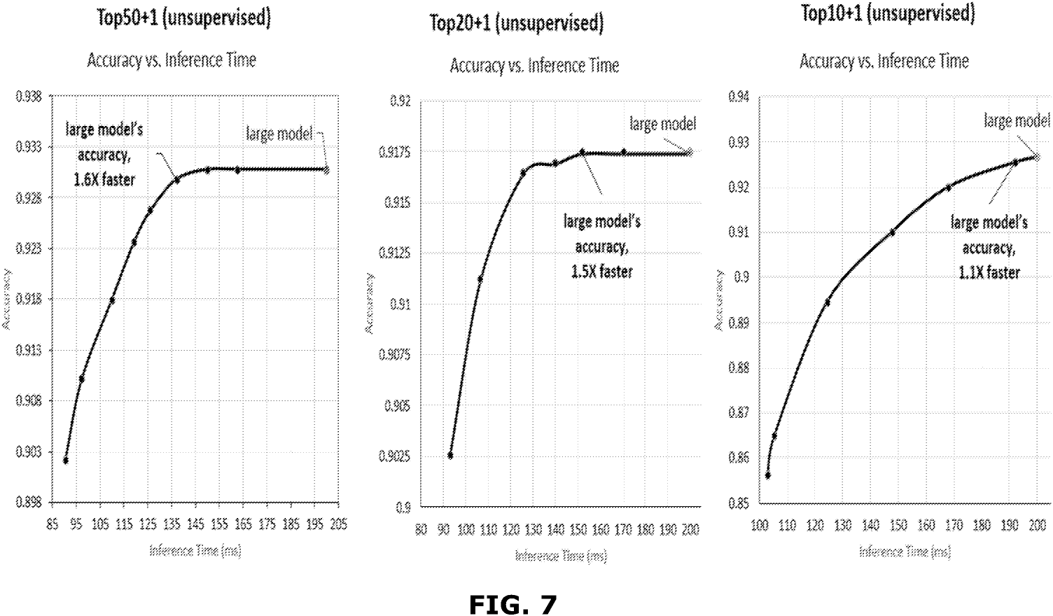

In examples where a user is to select a value for N, generation module 520 may be configured to present a user with information analyzing the effect of different N selections on system performance. In this regard, FIG. 7 reflects the differences in the estimated performance of joint inference system 100 given N options of N=50, N=20 and N=10. The larger the value of N, the faster the joint inference time as fewer data samples will be referred to the large model 114.

Finally, the ML algorithm 208 that corresponds to the small model architecture selected at 610 is used to train small model 112 to classify data samples according to the Top N +1 class labels.

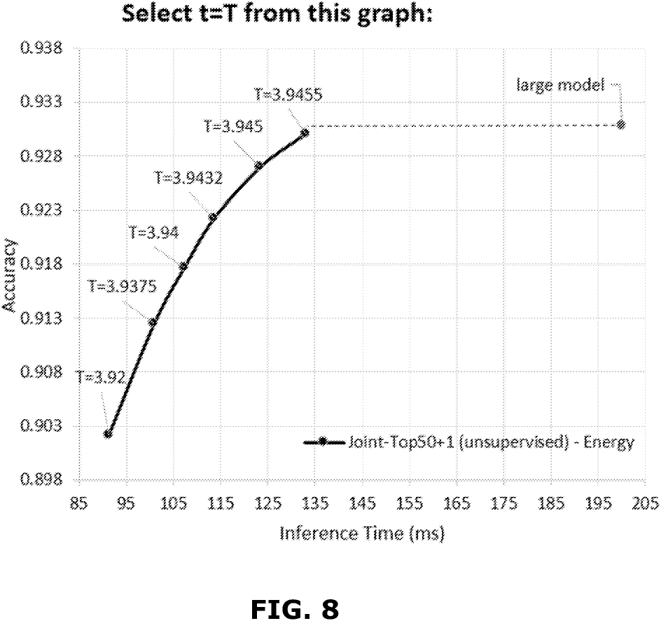

The process of FIG. 6 generates a small model 112 that can be used with selector module 116 and large model 112 to implement joint inference system 100. As indicated above, in some examples, the threshold value t applied by the joint inference system 100 can be user defined to allow the user to trade-off between speed and accuracy. In such examples, the joint inference system 100 may provide an interface (for example through an application program interface API available via user device 588) that enables the user to select a threshold value t (for example an energy threshold). Such interface may be configured to present a user with information analyzing the effect of different threshold value t selections on system performance. In this regard, FIG. 8 shows a plot of joint inference system 100 prediction accuracy versus inference time for different threshold values t.

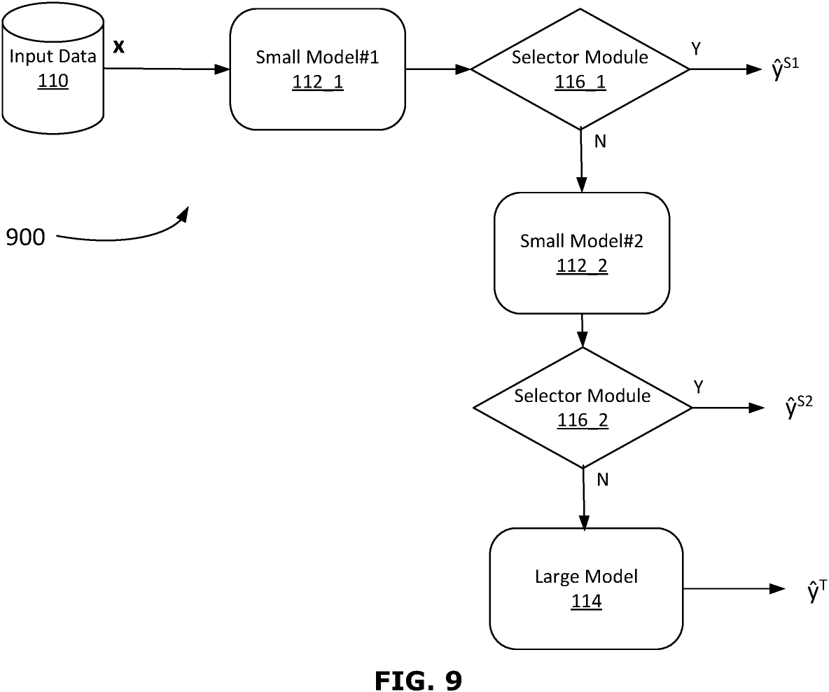

FIG. 9 illustrates a further example of a joint inference system 900 that is similar to joint inference system 100 except that the joint inference system 900 includes multiple small models (e.g., first small model 112_1 and second small model 112_2) with respective selector modules 116_1, 116_2. The small model 112_1 and small model 112_2 have each been trained using the same training dataset 204 but have been trained using a different Top N value. For example, Top N=N1 for the first small model 112_1 and Top N=N2 for the second small model 112_2, where N2 > N1. (By way of illustrative example, N2=10 and N1=5 may be possible values). If a prediction for an input data sample x that is made by the first small module 112_1 meets the prediction accuracy criteria applied by selector module 116_1, the class label corresponding to that prediction will be used as the output for the joint inference system 900. Otherwise, the input data sample x is routed to second small model 112_2 for a further prediction. If the further prediction meets the prediction accuracy criteria applied by selector module 116_2, the class label corresponding to the further prediction will be used as the output for the joint inference system 900. If the further prediction does not meet the prediction accuracy criteria applied by selector module 116_2, then input data sample x is routed to large model 114 for a further prediction that is used for the system, output. The respective selector modules 116_1, 116_2 can be configured with different prediction accuracy criteria and thresholds in some examples.

The joint inference system 900 can include more than two small model/selector module pairs in its processing chain. The configuration of joint inference system 900 enables the use of multiple small models that are each specialized on different label class subsets. The earlier occurring student model(s) can be small, faster models, and more accurate in a respective subtask, than subsequently occurring student model(s).

Among other things, the systems and methods described above can, in at least some applications, provide the one or more of following benefits. The joint inference system 100 enables on or more small/shallow ML models (low accuracy and low latency) to be combined with a large/deep ML model (high accuracy and high latency) to achieve a joint system that enables high accuracy and low latency. A joint inference system according to the present disclosure can be easy to generate and deploy as all that is needed for inputs is a trained large model 112 and an unlabeled dataset. Furthermore it is the disclosed joint inference system is architecture agnostic and applicable to different down-stream tasks (e.g., classification and object detection), and can be applied to existing pre-trained models (with no need for re-training).The energy-based routing mechanism for directing input samples enables a dynamic trade-off between accuracy and computational cost. The ability distil the large model to a small model can be beneficial for cases where users provide large models as input, without labeled data, with the objective of building an efficient inference pipeline. Creating a small model specialized for a subset of tasks (e.g., top-C classes only) with high accuracy, along with a plus-one (+1) mechanism, to distinguish the top-N-class data from other samples, can improve inference speed and prediction accuracy in some applications.

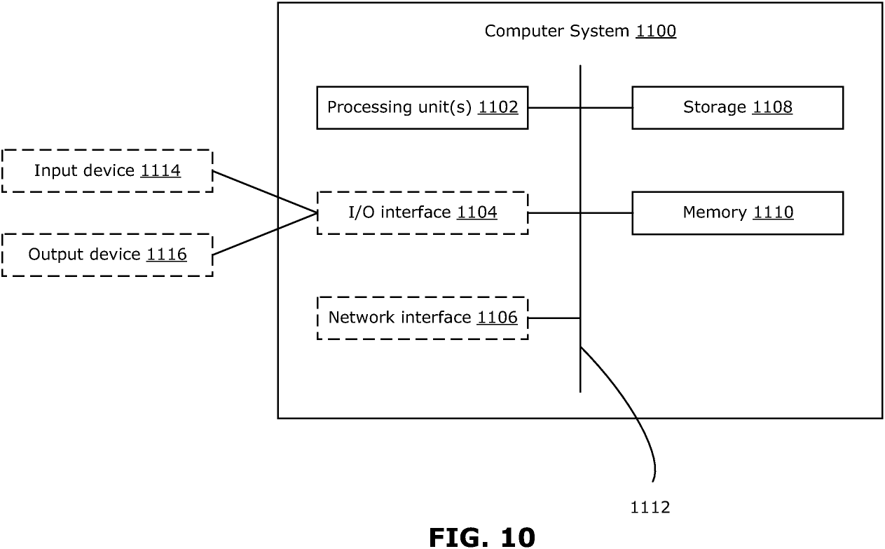

FIG. 10 is a block diagram of an example simplified computer system 1100, which may be part of a system or device that implements the selector module 116, small model 114, large model 112, training module and/or more of the other functions, modules, modes, systems and/or devices described above. Other computer systems suitable for implementing embodiments described in the present disclosure may be used, which may include components different from those discussed below. Although FIG. 10 shows a single instance of each component, there may be multiple instances of each component in the computer system 1100.

The computer system 1100 may include one or more processing units 1102, such as a processor, a microprocessor, an application-specific integrated circuit (ASIC), a field-programmable gate array (FPGA), or combinations thereof. The one or more processing units 1102 may also include other processing units (e.g. a Neural Processing Unit (NPU), a tensor processing unit (TPU), and/or a graphics processing unit (GPU)).

Optional elements in FIG. 10 are shown in dashed lines. The computer system 1100 may also include one or more optional input/output (I/O) interfaces 1104, which may enable interfacing with one or more optional input devices 1114 and/or optional output devices 1116. In the example shown, the input device(s) 1114 (e.g., a keyboard, a mouse, a microphone, a touchscreen, and/or a keypad) and output device(s) 1116 (e.g., a display, a speaker and/or a printer) are shown as optional and external to the computer system 1100. In other examples, one or more of the input device(s) 1114 and/or the output device(s) 1116 may be included as a component of the computer system 1100. In other examples, there may not be any input device(s) 1114 and output device(s) 1116, in which case the I/O interface(s) 1104 may not be needed.

The computer system 1100 may include one or more optional network interfaces 1106 for wired (e.g. Ethernet cable) or wireless communication (e.g. one or more antennas) with a network (e.g., an intranet, the Internet, a P2P network, a WAN and/or a LAN).

The computer system 1100 may also include one or more storage units 1108, which may include a mass storage unit such as a solid-state drive, a hard disk drive, a magnetic disk drive and/or an optical disk drive. The computer system 1100 may include one or more memories 1110, which may include both volatile and non-transitory memories (e.g., a flash memory, a random access memory (RAM), and/or a read-only memory (ROM)). The non-transitory memory(ies) 1110 may store instructions for execution by the processing unit(s) 1102 to implement the features and modules and ML models disclosed herein. The memory(ies) 110 may include other software instructions, such as implementing an operating system and other applications/functions.

Examples of non-transitory computer-readable media include a RAM, a ROM, an erasable programmable ROM (EPROM), an electrically erasable programmable ROM (EEPROM), a flash memory, a CD-ROM, or other portable memory storage.

There may be a bus 1112 providing communication among components of the computer system 1100, including the processing unit(s) 1102, optional I/O interface(s) 1104, optional network interface(s) 1106, storage unit(s) 1108 and/or memory(ies) 1110. The bus 1112 may be any suitable bus architecture, including, for example, a memory bus, a peripheral bus or a video bus.

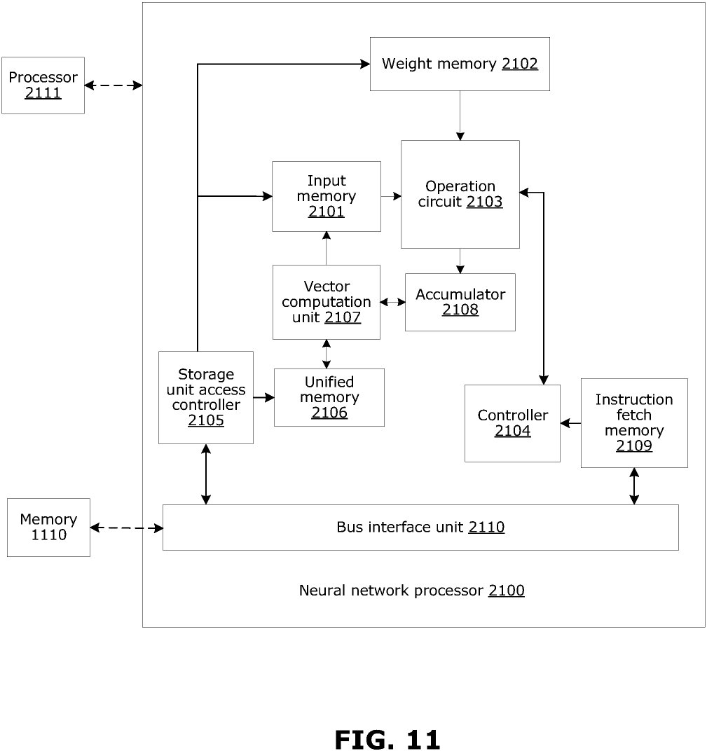

FIG. 11 is a block diagram illustrating an example hardware structure of an example NN processor 2100 of the processing unit 102 to implement a NN model (such as large model 112 or small model 114) according to some example embodiments of the present disclosure. The NN processor 2100 may be provided on an integrated circuit (also referred to as a computer chip). All the algorithms of the layers of an NN may be implemented in the NN processor 2100.

The processing units (s) 1102 (FIG. 10) may include a further processor 2111 in combination with NN processor 2100. The NN processor 2100 may be any processor that is applicable to NN computations, for example, a Neural Processing Unit (NPU), a tensor processing unit (TPU), a graphics processing unit (GPU), or the like. The NPU is used as an example. The NPU may be mounted, as a coprocessor, to the processor 2111, and the processor 2111 allocates a task to the NPU. A core part of the NPU is an operation circuit 2103. A controller 2104 controls the operation circuit 2103 to extract matrix data from memories (2101 and 2102) and perform multiplication and addition operations.

In some implementations, the operation circuit 2103 internally includes a plurality of processing units (Process Engine, PE). In some implementations, the operation circuit 2103 is a bi-dimensional systolic array. Besides, the operation circuit 2103 may be a uni-dimensional systolic array or another electronic circuit that can implement a mathematical operation such as multiplication and addition. In some implementations, the operation circuit 2103 is a general matrix processor.

For example, it is assumed that there are an input matrix A, a weight matrix B, and an output matrix C. The operation circuit 2103 obtains, from a weight memory 2102, weight data of the matrix B and caches the data in each PE in the operation circuit 2103. The operation circuit 2103 obtains input data of the matrix A from an input memory 2101 and performs a matrix operation based on the input data of the matrix A and the weight data of the matrix B. An obtained partial or final matrix result is stored in an accumulator (accumulator) 2108.

A unified memory 2106 is configured to store input data and output data. Weight data is directly moved to the weight memory 2102 by using a storage unit access controller 2105 (Direct Memory Access Controller, DMAC). The input data is also moved to the unified memory 2106 by using the DMAC.

A bus interface unit (BIU, Bus Interface Unit) 2110 is used for interaction between the DMAC and an instruction fetch memory 2109 (Instruction Fetch Buffer). The bus interface unit 2110 is further configured to enable the instruction fetch memory 2109 to obtain an instruction from the memory 1110, and is further configured to enable the storage unit access controller 2105 to obtain, from the memory 1110, source data of the input matrix A or the weight matrix B.

The DMAC is mainly configured to move input data from memory 1110 Double Data Rate (DDR) to the unified memory 2106, or move the weight data to the weight memory 2102, or move the input data to the input memory 2101.

A vector computation unit 2107 includes a plurality of operation processing units. If needed, the vector computation unit 2107 performs further processing, for example, vector multiplication, vector addition, an exponent operation, a logarithm operation, or magnitude comparison, on an output from the operation circuit 2103. The vector computation unit 2107 is mainly used for computation at a neuron or a layer (described below) of a neural network.

In some implementations, the vector computation unit 2107 stores a processed vector to the unified memory 2106. The instruction fetch memory 2109 (Instruction Fetch Buffer) connected to the controller 2104 is configured to store an instruction used by the controller 2104.

The unified memory 2106, the input memory 2101, the weight memory 2102, and the instruction fetch memory 2109 are all on-chip memories. The memory 1110 is independent of the hardware architecture of the NPU 2100.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices, and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The units described as separate parts may or may not be physically separate, and parts displayed as units may or may not be physical units, may be located in one position, or may be distributed on a plurality of network units. Some or all of the units may be selected according to actual requirements to achieve the objectives of the solutions of the embodiments.

In addition, functional units in the example embodiments may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this disclosure essentially, or the part contributing to the prior art, or some of the technical solutions may be implemented in a form of a software product. The software product is stored in a storage medium and includes several instructions for instructing a computer device (which may be a personal computer, a server, or a network device) to perform all or some of the steps of the methods described in the embodiments of this application. The foregoing storage medium includes any medium that can store program code, such as a universal serial bus (USB) flash drive, a removable hard disk, a read-only memory (ROM), a random access memory (RAM), a magnetic disk, or an optical disc, among others.

The foregoing descriptions are merely specific implementations but are not intended to limit the scope of protection. Any variation or replacement readily figured out by a person skilled in the art within the technical scope shall fall within the scope of protection. Therefore, the scope of protection shall be subject to the protection scope of the claims.

1. A method for predicting a label for an input sample, comprising
predicting a first label for the input sample using a first machine learning (ML) model that has been trained to map samples to a first set of labels;
determining if the first label satisfies prediction accuracy criteria;
when the first label satisfies the prediction accuracy criteria, outputting the first label as the predicted label for the input sample; and
when the first label does not satisfy the prediction accuracy criteria, predicting a second label for the input sample using a second ML model that has been trained to map samples to a second set of labels that includes the first set of labels and a set of additional labels, and outputting the second label as the predicted label for the input sample.

2. The method of claim 1 wherein the determining if the first label satisfies the prediction accuracy criteria comprises evaluating if the input sample is in-distribution relative to a distribution that corresponds to the first set of labels, wherein when the input sample is evaluated to be in-distribution then the first label satisfies the prediction accuracy criteria.

3. The method of claim 2 wherein the first ML model predicts a probability for each of the labels included in the first set of labels, wherein evaluating if the input sample is in-distribution comprises: determining a free energy value for the input sample based on the predicted probabilities for all of the labels included in the first set of labels; and comparing the free energy value to a defined threshold to determine when prediction accuracy criteria is satisfied.

4. The method of claim 2 wherein the first ML model predicts a probability for each of the labels included in the first set of labels, wherein evaluating if the input sample is in-distribution comprises: determining an entropy value for the input sample based on the predicted probabilities for all of the labels included in the first set of labels; and comparing the entropy value to a defined threshold to determine when prediction accuracy criteria is satisfied.

5. The method of claim 1 wherein the first ML model is trained to map samples that fall within the set of additional labels to a further label, and determining if the first label satisfies prediction accuracy criteria comprises, prior to evaluating if the input sample is in-distribution, determining if the first label predicted for the input sample corresponds to the further label, and if so then determining that the first label does not satisfy the prediction accuracy criteria.

6. The method of claim 1 wherein the first ML model is a smaller ML model than the second ML model.

7. The method of claim 1 wherein the first ML model and the second ML model are executed on a first computing system, the method including receiving the input sample at the first computing system through a network and returning the predicted label through the network.

8. The method of claim 1 wherein the first ML model is executed on a first device and the second ML model is executed on a second device, the method comprising transmitting the input sample from the first device to the second device when the first label does not satisfy the prediction accuracy criteria.

9. The method of claim 1 comprising, prior to predicting the first label, training the first model by:
predicting labels for a set of unlabeled data samples using the second ML model to generate a set of pseudo-labeled data samples that correspond to the second set of labels;
determining a subset of the second set of labels to include in the first set of labels based on the frequency of occurrence of the labels in the set of pseudo-labeled data samples;
training the first ML model using the set of pseudo-labeled data samples to map samples to the first set of labels.

10. The method of claim 9 wherein training the first ML model comprises training the first ML model to map samples that fall within the set of additional labels to a further label that corresponds to all of the second set of labels that are not included in the first set of labels.

11. The method of claim 1 wherein the first ML model and the second ML model are deep neural network models and the first ML model has fewer NN layers than the second ML model.

12. A method for predicting a label for an input sample, comprising
predicting a first label for the input sample using a first machine learning (ML) model that has been trained to map samples to a first set of labels by predicting respective probabilities for all of the labels included in the first set of labels;
determining a free energy value for the input sample based on the predicted probabilities for all of the labels included in the first set of labels;
comparing the free energy value to a defined threshold to determine if a prediction accuracy criteria is satisfied;
when the prediction accuracy criteria is satisfied, outputting the first label as the predicted label for the input sample, and when the prediction accuracy criteria is not satisfied predicting a second label for the input sample using a second ML model that has been trained to map samples to a second set of labels and outputting the second label as the predicted label for the input sample.

13. A computer system comprising one or more processing units and one or more memories storing computer implementable instructions for execution by the one or more processing devices, wherein execution of the computer implementable instructions configures the computer system to:
predict a first label for the input sample using a first machine learning (ML) model that has been trained to map samples to a first set of labels;
determine if the first label satisfies prediction accuracy criteria;
when the first label satisfies the prediction accuracy criteria, output the first label as the predicted label for the input sample; and
when the first label does not satisfy the prediction accuracy criteria, predict a second label for the input sample using a second ML model that has been trained to map samples to a second set of labels that includes the first set of labels and a set of additional labels, and output the second label as the predicted label for the input sample.

14. The computer system of claim 13 wherein the computer system is configured to determine if the first label satisfies the prediction accuracy criteria by evaluating if the input sample is in-distribution relative to a distribution that corresponds to the first set of labels, wherein when the input sample is evaluated to be in-distribution then the first label satisfies the prediction accuracy criteria.

15. The computer system of claim 14 wherein the first ML model predicts a probability for each of the labels included in the first set of labels, wherein evaluating if the input sample is in-distribution comprises: determining a free energy value for the input sample based on the predicted probabilities for all of the labels included in the first set of labels; and comparing the free energy value to a defined threshold to determine when prediction accuracy criteria is satisfied.

16. The computer system of claim 14 wherein the first ML model predicts a probability for each of the labels included in the first set of labels, wherein evaluating if the input sample is in-distribution comprises: determining an entropy value for the input sample based on the predicted probabilities for all of the labels included in the first set of labels; and comparing the entropy value to a defined threshold to determine when prediction accuracy criteria is satisfied.

17. The computer system of claim 1 wherein the first ML model is trained to map samples that fall within the set of additional labels to a further label, and determining if the first label satisfies prediction accuracy criteria comprises, prior to evaluating if the input sample is in-distribution, determining if the first label predicted for the input sample corresponds to the further label, and if so then determining that the first label does not satisfy the prediction accuracy criteria.

18. The computer system of claim 1 wherein the first ML model is a smaller ML model than the second ML model.

19. The computer system of claim 1, wherein the computer system is configured to, prior to predicting the first label, train the first model by:
predicting labels for a set of unlabeled data samples using the second ML model to generate a set of pseudo-labeled data samples that correspond to the second set of labels;
determining a subset of the second set of labels to include in the first set of labels based on the frequency of occurrence of the labels in the set of pseudo-labeled data samples; and
train the first ML model using the set of pseudo-labeled data samples to map samples to the first set of labels.

20. A computer readable medium storing non-transient computer implementable instructions that configures a computer system to perform a method of:
predicting a first label for the input sample using a first machine learning (ML) model that has been trained to map samples to a first set of labels;
determining if the first label satisfies prediction accuracy criteria;
when the first label satisfies the prediction accuracy criteria, outputting the first label as the predicted label for the input sample; and
when the first label does not satisfy the prediction accuracy criteria, predicting a second label for the input sample using a second ML model that has been trained to map samples to a second set of labels that includes the first set of labels and a set of additional labels, and outputting the second label as the predicted label for the input sample.
